(19) United States
(12) Patent Application Publication
(10) Pub. No.: US 2005/0115373 A1
(43) Pub. Date: Jun. 2, 2005

(54) Antibacterial coating on microtome operating parts

(75) Inventor: Stefan Kunkel, Karlsruhe (DD)

Correspondence Address: FOLEY AND LARDNER;SUITE 500, 3000 K STREET NW, WASHINGTON, DC, 20007, US

(73) Assignee: LEICA MICROSYSTEMS NUSSLOCH GmbH

(21) Appl. No.: 10/983,687

(22) Filed: Nov. 9, 2004

(30) Foreign Application Priority Data
Nov. 11, 2003 (DE) 103 52 578.5

(51) Int. Cl. B26D 7/00

(52) U.S. Cl. 83/168; 83/915.5

(57) ABSTRACT

A description is given of a microtome with functional areas to be manually operated, such as for example a sample holder (2), cutting device (3), cutting delivery (4) and cutting bin (5), which is distinguished by the fact that open and/or concealed surfaces of the structural elements for constructing the functional areas have a coating or doping with soluble silver ions.

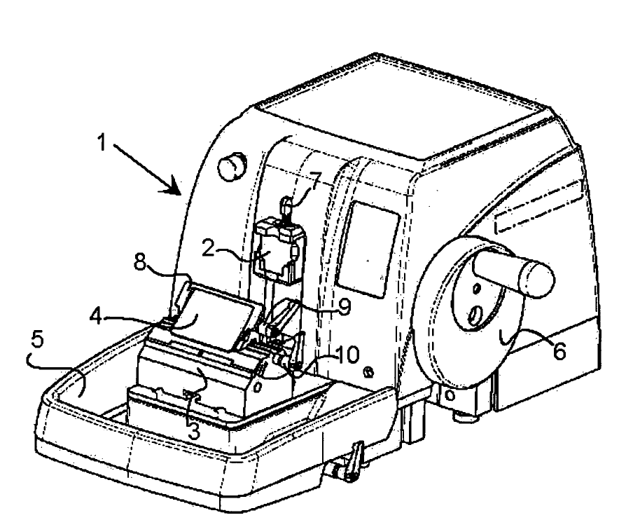

The invention relates to a microtome with the features of the preamble of claims 1 and 7.

Microtomes of this type are known per se and are used predominantly for the production of thin paraffin sections in the area of biology, medicine and industrial research. In this case, the specimens and preparations to be investigated are usually embedded in paraffin in an object holding device, for example a carrier basket, in a prior preparational process. For cutting, a drive device which, by means of a relative movement, guides the specimen located in the object holding device over the cutter arranged on the microtome is provided. The cutter is in this case generally horizontally displaceable in a cutter holding device and can be clamped in place at an adjustable angle in a defined manner.

In the case of what are known as rotary microtomes, the drive device accomplishes both the movement of the cutter holding device that is referred to as horizontal advancement, in adjustable micrometer increments, and the vertical cutting movement, which is usually produced by a crank mechanism driven by a hand wheel.

To produce an optimum cut surface, a trimming function may be provided. For this purpose, the cutter holding device can be manually made to approach the vertically movable object holding device in large increments in comparison with the actual cut thickness by means of a trimming lever for first cutting operations. This operation produces unusable cutting waste, which is collected in a cutting bin of the microtome.

The specimens to be investigated are often contaminated or bacterially charged biological material. Regular cutting of the specimens with the microtome also unavoidably produces fine cutting waste, which falls from the microtome cutter and is deposited on parts of the microtome lying underneath, especially also in open gaps and in particular in the cutting bin.

On account of the quite complicated sequence of movements, an elaborate mechanism is necessary on and in the microtome. Openings leading into the interior of the microtome unavoidably remain at interfaces between movements and are often covered over by movable slides. Likewise, small cracks, gaps and openings are produced by the production process on the microtome housing in the vicinity of the functional areas mentioned at the beginning.

To avoid infections being caused by the contaminated cutting waste, the operating personnel are obliged to intensively clean and disinfect the microtome, and in particular the operating elements of the functional areas, at relatively frequent time intervals.

The document U.S. Pat. No. 3,233,965 discloses a device for disinfecting the interior space of what is known as a cryostat microtome. In particular with regard to the low temperatures in a cryostat, it is proposed for this purpose to vaporize a cleaning chemical and subsequently heat up the interior space of the cryostat. FR 2 705 587 A1 discloses additional spraying of a disinfectant. In both cases, the interior space together with the microtome must be laboriously dried. Excessive exposure of the operating personnel to solvent-containing or other disinfectants cannot be ruled out. Only after renewed cooling to the working temperature can the implements be used again. The documents U.S. Pat. No. 5,681,575, WO 00/09 173 A1, WO 01/95 876 A1, WO 02/087 339 A1 and JP 06-229 970 A describe the antimicrobial effect of silver ions as being generally known, and present them in particular for coating medical implements that are used directly on a patient. Mentioned by way of example are catheters, which are used by a doctor for treating a patient. In surgical operations, metal implants are inserted into the body by the doctor in attendance. The medical implements mentioned in these documents have to meet increased requirements with regard to sterile packing and storage. The rapid decrease in the number of effective silver ions in the surface and the associated poor long-term effect with regard to antimicrobial behavior are stated as disadvantageous. To improve the long-term effect, a chemical method which is intended to improve the ion release, in particular in contact with body fluids, is therefore specified in U.S. Pat. No. 5,681,575 for example. WO 00/09 173 A1 discloses an elaborate and complex structure of a coating for catheters, which is intended to counteract the oxidation process of the surface doped with silver ions and consequently counteract a discoloration which has disadvantageous effects on the long-term ion release. In WO 01/95 876 A1, prior cleaning and additional wetting with antimicrobial agents is proposed to provide an improvement in catheter applications. Because the material properties change disadvantageously as a result of the doping of metals with silver ions, a powder coating with an antimicrobial effect and production thereof have been proposed in WO 02/087 339 A1.

WO 00/07 633 A1 discloses a surgical microscope with a special antimicrobial coating, which is employed specifically for use in the sterile environment of an operating area close to the patient undergoing an operation. All the documents relate to the area of medical technology, and there in particular to implements and equipment for invasive interventions on patients. Possible use in areas which do not have high requirements with regard to sterility, such as for example the general laboratory area in which microtomes are used, is not envisaged.

It is therefore known from the prior art to spray liquid disinfectant onto the microtome and its operating elements and rub it off with a cloth. However, narrow cracks and gaps in particular cannot be properly cleaned in this way. Cleaning of the operating elements that are in direct contact with the contaminated specimens and preparations proves to be particularly difficult. For example, on account of their mechanical design, the object holding device and the cutter holding device specifically often have a large number of small depressions for receiving screws and clamping devices. Rotary setting wheels also have around their clamping circumference cracks in which cutting waste accumulates especially.

Therefore, in spite of supposedly intensive cleaning with a liquid disinfectant, a not inconsiderable amount of contaminated cutting waste often remains adhering to the microtome and its operating elements. It is likewise problematical that solvent-containing disinfectants adversely affect the skin and organisms of the operating personnel.

The cutting bin is contaminated to a particularly great extent, since both the cutting waste from trimming cuts and thin sections of contaminated specimens that fall off collect in it. Pieces of cutting waste that adhere over a large surface area and stick particularly firmly on the surface represent a special cleaning problem.

The object of the invention is therefore to improve the disinfecting and cleaning properties for a microtome in the functional area where there is a particularly high accumulation of contaminated cutting waste. The operating personnel are at the same time to be protected from excessive exposure to solvent-containing or other disinfectants. By improving the cleaning properties, it is also intended to save costs and effectively prevent exposure of the microtome to fungal and mildew attack.

This object is achieved according to the invention by the defining features of claims 1 and 7. Advantageous refinements and developments of the invention are provided by the features of the subclaims.

The invention is distinguished by the fact that the surface of the cutting bin has a direct antibacterial and disinfectant effect on adhering and falling-off contaminated cuttings. It has additionally been found to be particularly advantageous to provide other affected elements of the microtome, such as parts of the object holding device, parts of the cutter holding device or the hand crank, also with the coating or doping containing the soluble silver ions already during production, that is to say before assembly. These measures surprisingly produce specifically in the narrowest cracks, gaps, depressions and housing openings an increased accumulation of free silver ions, which display their antimicrobial and antiseptic effect particularly effectively at those places where conventional cleaning with liquid disinfectants specifically fails.

By means of a coating or doping which comprises a release system with constant and uniform liberation of silver ions, the cutting bin of the microtome is permanently protected from germs and bacteria.

In a refinement of the invention, the coating comprises a powder coating as a carrier for storing the silver ions, which in this way can be applied to the cutting bin in a particularly simple and cost-saving way during the production process. Free silver ions can be stored particularly advantageously in a ceramic material as the carrier, which likewise allows varied coating technology for application to metal surfaces and at the same time, as a release system, ensures a maximum antimicrobial effect.

It has been found that it is likewise advantageous if the release system comprises a plastic with incorporated ceramic carriers for storing the silver ions. Such a plastic can be used under virtually all conceivable production and processing conditions and can be adapted in its mechanical properties by customary additives, such as for example fiber reinforcements, to the special conditions for constructing the cutting bin of a microtome.

Other structural elements which are subjected to lower mechanical loading may also be sprayed directly with antimicrobial plastic. For example, the hand crank or the cutting bin can be produced at low cost in this way, but also be created simply as an exchangeable part for retrofitting. These structural elements, which are then also exchangeable, consequently make a greater contribution to protection from infections.

In a further refinement of the invention, the surface of the coating is additionally formed to repel dirt. The silver ions released at the surface are available to act on the cuttings that still adhere, but are reduced in their amount.

For this purpose, it is particularly advantageous to make the structure of the surface of the coating replicate the lotus effect.

In a further refinement of the invention, the bin to be coated is made from aluminum, high-grade steel or plastic. Aluminum ensures particularly good bonding of the powder coating and plastic is inexpensive in production. Plastic also offers the advantage that, when producing the cutting bin, which is particularly subjected to falling-off cuttings, the antimicrobial effect can be ensured for a long time by incorporating in the processed plastic a ceramic carrier material for storing the silver ions.

The invention is described and explained in more detail below on the basis of an exemplary embodiment schematically represented in the drawing.

The illustration shows a rotary microtome 1 with functional areas to be manually operated, that is a specimen holder 2, cutting device 3 and cutting delivery 4. The cuttings falling off from the cutting delivery 4 are collected in the cutting bin 5. The up and down movement of the specimen holder 2 and the infeed of the cutting device 3 are controlled by actuation of a hand crank 6 by means of a mechanism that is not represented any further.

The functional units are obviously constructed from a plurality of structural elements. For rapidly exchanging a specimen carrier (not represented), a clamping lever 7 is provided. The microtome cutter 8 may also be adjusted and fixed in a pivotable cutter receptacle by means of clamping shafts 9, 10. The cutting device 3 is mounted on concealed guide rails. Owing to the structural design, difficult-to-access cavities and narrow cracks and joints in which contaminated cuttings can accumulate are produced when the various structural elements are joined together. Manipulation with the specimen at the functional areas 2, 3, 4, 5 can also cause contaminated material to be transferred to the hand crank 6.

The open surfaces and the concealed surfaces of the structural elements described may be provided with a coating which contains soluble silver ions before assembly. Powder coatings with incorporated silver ions are particularly suitable as the coating material. Experience shows that such powder coatings have particularly good adhesive strength on aluminum. Many of the structural elements may be made of this material. If a different metal has to be used, such as for example in the case of the microtome cutter and in the case of pivot bearings, targeted doping of the surface with silver ions may take place.

Where structural elements of the functional areas can be made of plastic, it is advantageous to use a plastic with incorporated ceramic material as a carrier for silver ions. In particular, the grip on the hand crank, the toggle on the clamping shafts and the cutting bin may be made of such a plastic, so that the parts touched by the operating person when setting up and operating the microtome are particularly well protected from contamination.

Moisture is conducive to the release of the silver ions. Since water from condensation or residual moisture from previous mechanical cleaning operations remains in particular in the difficult-to-access cracks and joints, silver ions are released to a greater extent at these possibly contaminated locations. The customary mechanical cleaning process can therefore be performed with less care.

A carelessness that is usually to be condemned can be turned into an advantage by the invention.

### List of Designations

1 rotary microtome
2 specimen holder
3 cutting device
4 cutting delivery
5 cutting bin
6 hand crank
7 clamping lever
8 microtome cutter
9, 10 clamping shafts

1) a microtome with functional areas to be manually operated, in particular a sample holder (2), cutting device (3), cutting delivery (4) and cutting bin (5), wherein the cutting bin (5) is made of aluminum, high-grade steel or plastic and has a coating which comprises a release system with constant and uniform liberation of silver ions.

2) The microtome as claimed in claim 1, wherein the coating comprises a powder coating as a carrier for storing the silver ions.

3) The microtome as claimed in claim 1, wherein the release system includes a ceramic carrier for storing the silver ions.

4) The microtome as claimed in claim 1, wherein the release system includes a plastic with an incorporated ceramic carrier for storing the silver ions.

5) The microtome as claimed in claim 2, wherein the coating is formed to repel dirt.

6) The microtome as claimed in claim 5, wherein the structure of the surface of the coating is made to replicate the lotus effect.

7) A microtome with functional areas to be manually operated, in particular a sample holder (2), cutting device (3), cutting delivery (4) and cutting bin (5), wherein the cutting bin (5) is made of a plastic with an incorporated ceramic carrier for storing the silver ions.
